(19) United States
(12) Patent Application Publication
(10) Pub. No.: US 2004/0231203 A1
(43) Pub. Date: Nov. 25, 2004

(54) Presentation apparatus

(76) Inventors: Peter Dobelbower, Oklahoma City, OK (US); Michael Bilcik, Yukon, OK (US)

Correspondence Address: Richard D. Harris, GREENBERG TRAURIG, P.C., Suite 2500, 77 West Wacker Drive, Chicago, IL, 60601, US

(21) Appl. No.: 10/444,742

(22) Filed: May 23, 2003

(51) Int. Cl. G09F 1/00

(52) U.S. Cl. 40/124.09; 40/124.191

(57) ABSTRACT

A presentation apparatus, in the form of a blank, divided by advantageously disposed vertically extending cuts, into a plurality of interconnected, relatively foldable panels, is provided. The presentation apparatus is foldable into a compact form, having a width approximately that of a single one of its constituent panels. Structures for providing selective relative rigidity of adjacent ones of the panels are provided, as are structures for providing upright stability of the presentation apparatus.

### BACKGROUND OF THE INVENTION

1. Field of the Invention

The present invention relates in general to apparatus for presentation or display of planar or sheet material, wherein the apparatus for presentation are configured to be placed on top of a horizontal support surface, such as a table top, and the planar or sheet material is to be affixed to a vertical surface of the presentation apparatus. The present invention relates in particular to such presentation apparatus that are fabricated from paper, paperboard and/or corrugated paperboard. The present invention also relates to such presentation apparatus that are configured to be portable, by articulation into smaller configurations, when not in use.

2. Background Art

Presentation apparatus configured for placement on table-tops, for use, for example, in the presentation of educational displays, are known. Such apparatus have been known to have been fabricated from paper, paperboard and/or corrugated paperboard.

Examples of such apparatus are disclosed in Wood, U.S. Pat. No. 4,794,712; Wood, U.S. Pat. No. 5,293,705; Wood, U.S. Pat. No. 5,960,848; Schirer, U.S. Pat. No. 5,960,848.

Wood, U.S. Pat. No. 4,794,712 discloses a portable presentation device formed from a combination of corrugated paperboard and paper materials, formed into a plurality of panels (specifically, three panels). Adjacent panels are separated by score lines to permit the portable presentation device to be folded into a more compact form. Each panel has a base portion, including first and second substantially rigid corrugated sections, separated by a rigid member and a writing surface adhered to the outer surface of the first corrugated substantially rigid section. That is, the first and second corrugated substantially rigid sections may be represented by a single sheet of what is referred to in the field of corrugated paperboard manufacture as doublewall corrugated material, in which the center layer of linerboard is of substantially increased thickness and/or rigidity, relative to the outer layers of linerboard. The writing surface may be provided as a further sheet of paper or linerboard applied to one surface of the doublewall corrugated material. The score line formed between adjacent panels extends entirely through the second corrugated substantially rigid section and a portion of the first corrugated substantially rigid section such that adjacent panels can be folded relative to each other.

Wood, U.S. Pat. No. 5,293,705 and Wood, U.S. Pat. No. 5,960,848 disclose, in addition to the apparatus described with respect to Wood, U.S. Pat. No. 4,794,712, an embodiment in which the presentation apparatus is formed from a blank of essentially single wall corrugated material. That is, a layer of corrugated material between two sheets of relatively rigid linerboard material, which itself may be a single layer or a composite.

In all of the Wood references, the three-panel construction is employed, with the central panel being at least twice the width of the adjacent side panels, which places a limitation on the ability to reduce the size of the overall apparatus when folded. Furthermore, in each of the Wood references, the flutes of the corrugations run horizontally, when the presentation apparatus is in its deployed configuration.

Schirer, U.S. Pat. No. 5,960,848 discloses a three-panel presentation apparatus, fabricated of outer sheets of material, which may be one of a variety of forms of linerboard (kraft, clay coated, bleached white or laminated paper), sandwiching a central layer of corrugated, solid fiber or foam core. In addition to the three panel construction, in which the outer panels fold inwardly over the center panel, a carrying handle may be diecut into the center panel, and a bracket structure may be integrally formed, with notches that engage the side panels, to hold them at an angle to the center panel. In addition, a separate bottom support, in the form of a plastic clip with a foot that extends perpendicular to the bottom edge of a panel it has been clipped to, may be provided to give further support to hold up the presentation device. An alternative bottom support, in the form of a “V”, and made from the same material as the panels, may alternatively be used.

A further prior art apparatus is a commercial available product, manufactured by Roaring Spring Blank Book Company, of Roaring Spring, Pa. This presentation apparatus is formed as a blank of singlewall material, being a layer of corrugated material sandwiched between two composite layers of linerboard material. Each composite linerboard layer is formed by an outer ply of bleached white paper, and an inner ply layer of kraft paper. The blank is monolithically formed, and subsequently divided into four consecutive, panels of approximately equal width and height. The center two panels are separated and defined by two lines of perforations in the outer plies of the linerboard layers. The inner ply of the linerboard layer and the inner corrugated layer are not perforated. The two outer panels are formed by longitudinal (i.e., vertically extending) cuts extending through one layer of linerboard and the corrugated layer.

The product is initially folded for transportation in a manner substantially identical to that of the Wood, U.S. Pat. No. 4,794,712 reference. That is, the two outermost panels are folded inwardly over the center two panels, which are not folded over one another. Thus, the initial package is the width of the two center panels. After the initial package has been opened, the presence of the lines of perforations separating the two center panels permits the two center panels to be folded relative to one another, for purposes of permitting the device to be folded into a tube. Any attempt to fold the device completely upon itself would require completely rupturing at least one of the lines of perforations, as well as a manual folding of the inner layer of corrugated material, which requires a significant amount of force to be exerted to overcome the inherent resistance to folding along a line perpendicular to the direction of the flutes of the corrugations. In addition, the perforations must be protected from rupture, prior to purchase and deployment by the consumer, in order to give the consumer the option whether or not to fold the two center panels relative to one another to form the tube.

It would be desirable to provide a presentation apparatus for positioning on a table top, for the presentation of planar materials.

It would be further desirable to provide such a presentation apparatus that is fabricated from paper, paperboard and/or corrugated paperboard material, and associated materials that are readily recycled.

It would be still further desirable to provide such a presentation apparatus that is readily foldable into a compact form for transportation.

These and other desirable characteristics of the invention will become apparent in view of the present specification, including the claims, and drawings.

### SUMMARY OF THE INVENTION

The present invention comprises a presentation apparatus, for providing a plurality of upright-oriented planar surfaces for the positioning and display of planar exhibit materials, comprising a planar blank, having a front face and a back face, a top edge and a bottom edge, and first and second end edges. A first cut is disposed in the planar blank, at a location substantially midway between the first and second edges, from the top edge to the bottom edge, and from the back face toward but not through the front face. A second cut is disposed in the planar blank substantially midway between the first cut and the first edge, from the top edge to the bottom edge and from the front face toward but not through the front face. A third cut is disposed in the planar blank substantially midway between the first cut and the second edge, from the top edge to the bottom edge and from the front face toward but not through the front face. The first, second and third cuts divide the planar blank into four consecutive panels having substantially equal widths, and enabling the planar blank to be folded upon itself in a pleated configuration, and unfolded and re-folded on a plurality of occasions, without having to overcome significant resistance to folding and without rupturing or destroying layers of the blank.

The presentation apparatus may further comprise structure for providing selective rigidity to the presentation apparatus, when at least two adjacent panels of the presentation apparatus are disposed in coplanar relationship to one another. The structure for providing selective rigidity may comprises an elongated clip, having a U-shaped cross-sectional configuration, operably configured to be removably placed over one of the top and bottom edges of the blank, along a transition between adjacent panels thereof, the elongated clip providing resistance to folding of one of the adjacent panels, relative to the other of the adjacent panels. Alternatively, the structure for providing selective rigidity may comprise a sheet of material having a top edge and a bottom edge, the sheet of material being affixed to one of the front and back faces of the planar blank, along a transition between adjacent panels thereof. The sheet is preferably affixed along the top and bottom edges thereof, to define an elongated passage extending between the sheet of material and the one of the front and back faces of the planar blank. A elongated rod is operably configured to be inserted into the elongated passage, and to extend along the transition between adjacent panels of the planar blank, when the adjacent panels have been disposed in coplanar relationship to one another.

The presentation apparatus may further comprise a structure for facilitating maintenance of the presentation apparatus in an upright configuration. The structure for facilitating maintenance of the presentation apparatus in an upright configuration may comprise at least one support bracket, having a clip portion, configured to releasably engage the planar blank along the bottom edge thereof, and an elongated leg, operably configured to extend away from the back face of the planar blank, at an included angle of less than 90 degrees relative thereto.

The planar blank preferably comprises a front outer layer, a back outer layer, and an inner layer. The front outer layer comprises at least one sheet of material, wherein the at least one sheet of material is preferably fabricated from one of: paper, kraft paper, bleached white paper, clay coated paper. The back outer layer comprises at least one sheet of material, wherein the at least one sheet of material preferably is fabricated from one of: paper, kraft paper, bleached white paper, clay coated paper. The inner layer preferably comprises a layer of corrugated material. The layer of corrugated material is preferably fabricated from paper.

### BRIEF DESCRIPTION OF THE DRAWINGS

FIG. 1 is a front elevation of a blank for a prior art presentation apparatus.

FIG. 2 is a top plan view of the blank for the prior art presentation apparatus of FIG. 1.

FIG. 3 is a side elevation of the blank for the prior art presentation apparatus of FIGS. 1 and 2.

FIG. 4 is a perspective view of the prior art presentation apparatus of FIGS. 1-3, shown in a deployed configuration.

FIG. 5 is a front elevation of a blank for a presentation apparatus according to a preferred embodiment of the invention.

FIG. 6 is a top plan view of the blank for the presentation apparatus of FIG. 5.

FIG. 7 is a side elevation of the blank for the presentation apparatus of FIGS. 5 and 6.

FIG. 8 is a perspective view of the presentation apparatus of FIGS. 5-7, shown in a deployed configuration.

FIG. 9 is a top plan view of the presentation apparatus of FIGS. 5-8, shown in its folded configuration.

FIG. 10 is a side elevation of a rigidity clip, for use with the presentation apparatus of FIGS. 5-9.

FIG. 11 is an end elevation of the rigidity clip of FIG. 10.

FIG. 12 is a bottom view of the rigidity clip of FIGS. 10 and 11.

FIG. 13 is a perspective view of the rigidity clip of FIGS. 10-12.

FIG. 14 is a rear elevation of an alternative embodiment of the presentation apparatus of the present invention, incorporating a selective rigidity structure, in an undeployed configuration

FIG. 15 is a side elevation of the presentation apparatus of FIG. 15.

FIG. 16 is a rear elevation of an alternative embodiment of the presentation apparatus of the present invention, incorporating a selective rigidity structure, in a deployed configuration

FIG. 17 is a side elevation of the presentation apparatus of FIG. 16.

FIG. 18 is a side elevation of a stabilizing device, for use with the presentation apparatus of the present invention.

FIG. 19 is a perspective view of the stabilizing device of FIG. 18.

### DETAILED DESCRIPTION OF THE INVENTION

While this invention is susceptible of embodiment in many different forms, there is shown in the drawings and will be described in detail several specific embodiments, with the understanding that the present disclosure is to be considered an exemplification of the principles of the invention and is not intended to limit the invention to the embodiments illustrated.

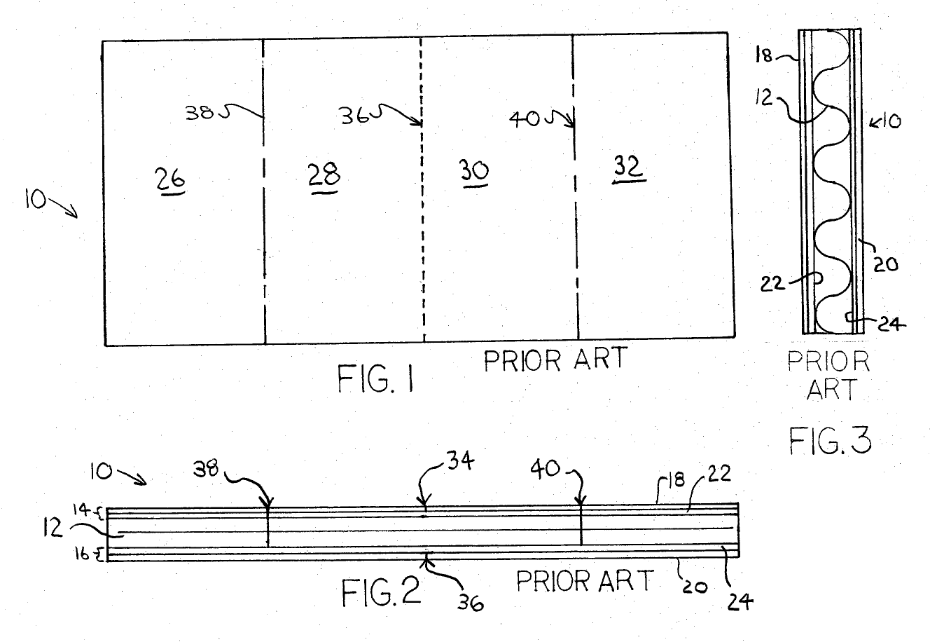

FIGS. 1-4 illustrate a prior art presentation apparatus 10, a commercially available product, manufactured by Roaring Spring Blank Book Company, of Roaring Spring, Pa. Note that the thickness of presentation apparatus 10 has been exaggerated in FIGS. 2-4, in order to facilitate illustration of the various layers of the blank, and FIGS. 2-4 are understood not to be scale representations, relative to the height and width proportions of the blank of apparatus 10, as shown in FIG. 1.

Prior art presentation apparatus 10 is formed as a blank of singlewall material, being a layer 12 of corrugated material (see FIGS. 2 and 3) sandwiched between two composite layers 14, 16 of linerboard material. Each composite linerboard layer 14, 16 may be formed by an outer ply 18, 20, of bleached white paper, and an inner ply 22, 24, of kraft paper. The blank is monolithically formed, and subsequently divided into four consecutive panels 26, 28, 30, 32 of approximately equal width and height. The center two panels 28, 30 are separated and defined by two lines 34, 36 of perforations in the outer plies only of the composite linerboard layers. The inner corrugated layer 12 is not perforated. The two outer panels 26, 32 are formed by longitudinal (i.e., vertically extending) cuts 38, 40 extending through linerboard layer 14 and corrugated layer 12.

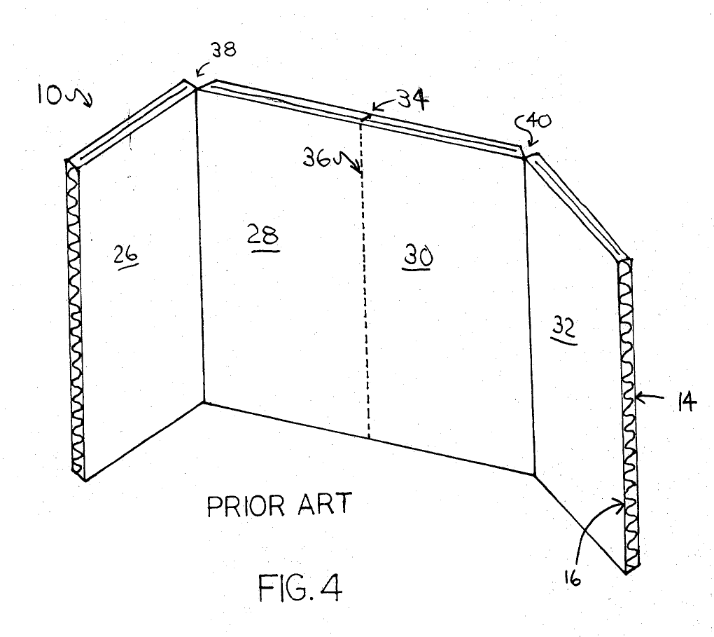

Apparatus 10 is initially folded in a manner substantially identical to that of Wood, U.S. Pat. No. 4,794,712. That is, the two outermost panels 26, are folded inwardly over the center two panels 28, 30, which are not folded over one another. Thus, the initial package is the collective width of the two center panels 28, 30. After the initial package has been opened (FIG. 4, wherein the individual layers of outer composite layers 14, 16 have been omitted), presentation apparatus 10 can be made to stand up, by folding panels 26, 32 at oblique angles relative to center panels 28, 30. The presence of the lines 34, 36 of perforations separating center panels 28, 30 permits the two center panels to be folded relative to one another, for the purpose of forming a tube. However, this folding entails rupturing at least one of the lines of perforations, as well as a manual folding of the inner layer of corrugated material, which requires a significant amount of force to be exerted to overcome the inherent resistance to folding along a line perpendicular to the direction of the flutes of the corrugations. Presentation apparatus 10 is not configured to permit the folding of center panels 28, 30 upon themselves, in the absence of destructive overextension of the joint.

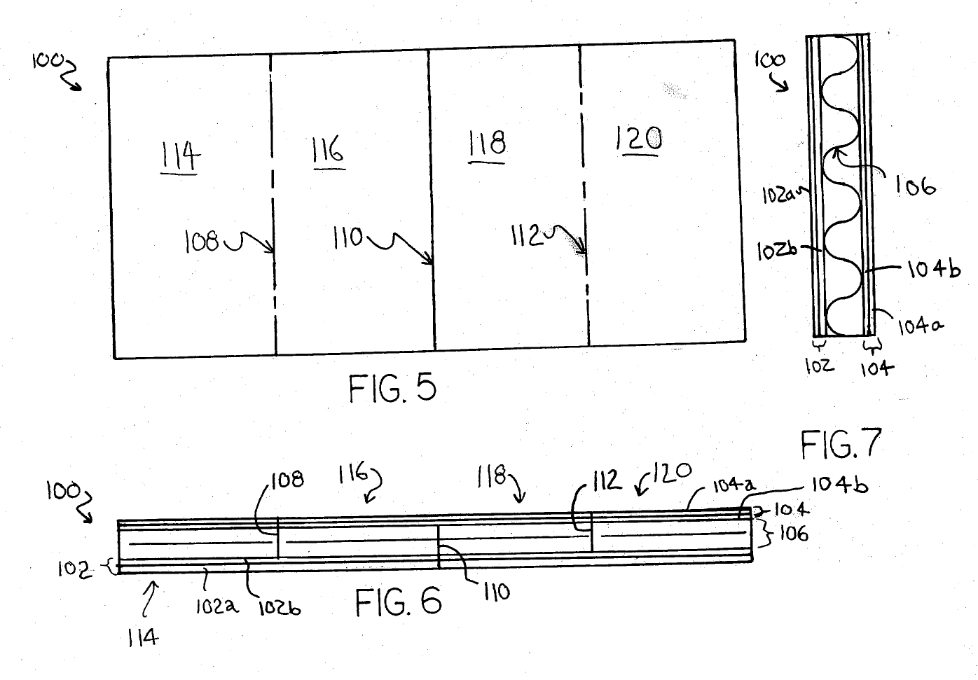

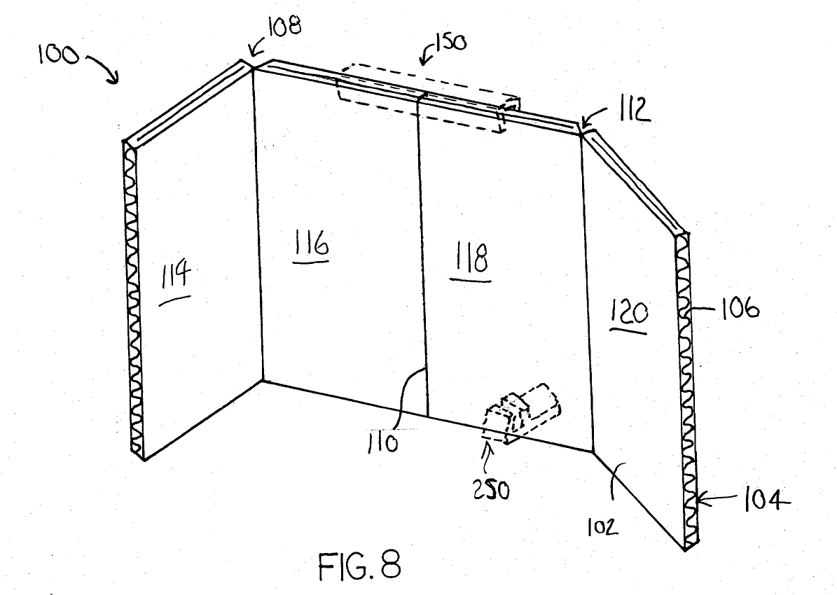

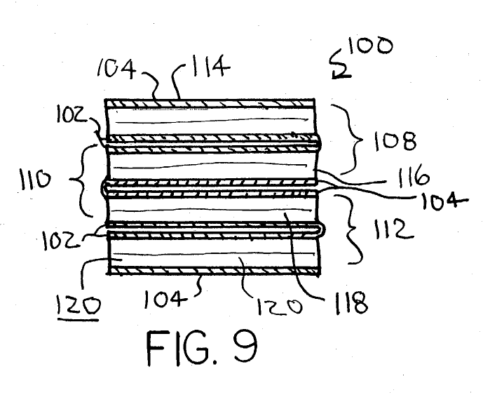

FIGS. 5-9 illustrate the presentation apparatus 100 according to a preferred embodiment of the invention. Presentation apparatus 100 is initially formed as a monolithic blank having outer layers 102, 104, and an inner layer 106 of corrugated material. In a preferred embodiment of the invention, outer layer 102 is formed from an first ply 102a of bleached white paper (to form the “front” side that faces toward the observer) and a second ply 102b of kraft paper, while outer layer 104 may be fabricated from two plies 104a, 104b of kraft paper (to form the “back” side that faces away from the observer). To facilitate illustration, plies 102a, 102b, 104a, 104b are shown only in FIGS. 6 and 7, but are understood to be present in FIGS. 8 and 9, which are of the same embodiment. In alternative embodiments, either or both of the outer layers 102, 104 may be fabricated from greater or fewer plies of material, and/or of different types of materials (such as laminated or coated materials), as desired or dictated by the requirements of a particular application. Likewise, no specific gauge of flute is required to be employed in the corrugated layer 106, and any gauge may be employed as desired or required. Furthermore, one or both of outer layers 102, 104 may be configured to have writable surfaces, and may be configured for facilitated adhesion by adhesive tape or glue, and may be configured to receive tacks or staples, or similar fasteners, as dictated by the presentation requirements of a particular application.

It is to be understood that in FIGS. 6-9, in which the thickness of apparatus 100 is represented, that the thickness has been exaggerated relative to the illustrated height and width of apparatus 100, for purposes of facilitating illustration of the various layers making up apparatus 100. It is further to be understood that the actual thickness of an apparatus 100 which may have dimensions, e.g., on the order of 4 feet (width) by 3 feet (height) may have a gross thickness (flat unfolded) on the order of ⅛ to 3/16 inches. It is to be additionally understood that the aspect ratio of height to width, as just given by example, or as illustrated in the drawings, is not intended to limit the scope of the invention, and that any suitable aspect ratio may be employed.

As stated above, apparatus 100 is initially monolithically formed, and is subsequently provided with three “vertically extending” cuts 108, 110, 112, which are approximately equally spaced apart. Cuts 108 and 112 extend from, and completely through, the “back” outer layer 104, toward “front” outer layer 102, and substantially or completely through corrugated layer 106. Cut 110, on the other hand, extends from, and completely through, “front” outer layer 102, toward “back” outer layer 104, and substantially or completely through corrugated layer 106. Cuts 108, 110 and 112 define relatively foldable panels 114, 116, 118 and 120. Cuts 108, 110, 112 permit presentation apparatus 100 to be folded, into a pleated, compact configuration, having a width approximately equal to the width of one panel. In addition, the pattern of cuts permits apparatus 100 to be folded, unfolded, and re-folded on a plurality of occasions, without having to overcome significant resistance to folding and without rupturing or destroying layers of the blank.

To facilitate the use of presentation apparatus 100, structures may be provided which will provide a selectively applicable rigidity to one or more of the joints created by cuts 108, 110, 112.

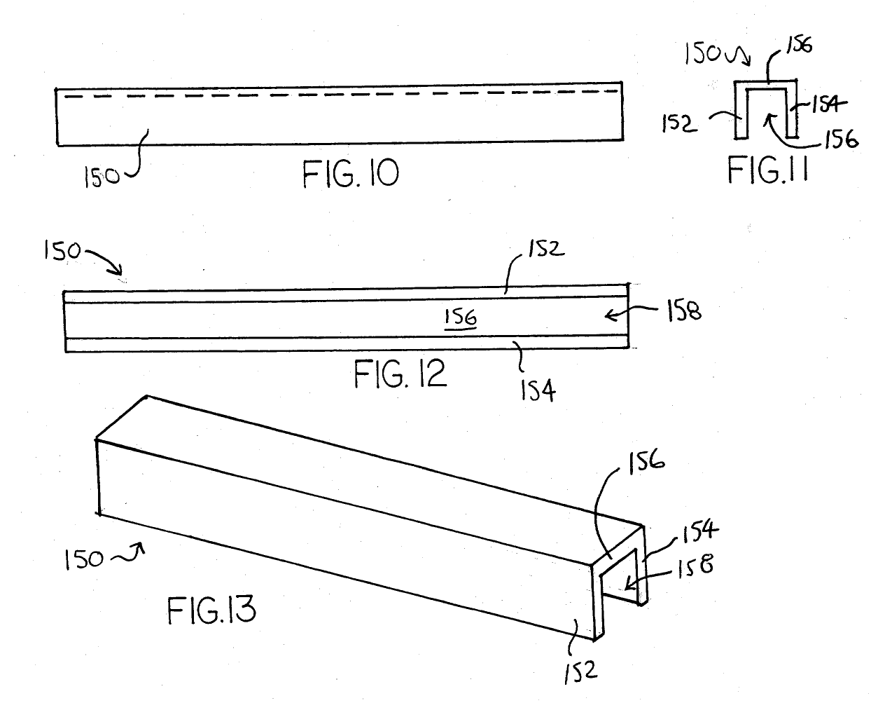

In one embodiment of the invention, the selective rigidity structure may be in the form of a removable rigidity clip 150, as shown in FIGS. 10-13. Clip 150, which preferably is fabricated from plastic, light metal, or some other suitably similar material, has, when viewed end-on, an inverted U-shaped configuration, with legs 152, 154, connected by web 156, defining a gap 158. The distance between legs 152, 154 may be, preferably, slightly less than the front-to-back thickness of presentation apparatus 100, so that the material of presentation apparatus 100 will be slightly compressed, when clip 150 is in place, as shown in broken lines in FIG. 8. The length and proportions of clip 150 as illustrated are shown by way of example, and are not intended to be limiting. For example, clip 150 may be formed to be long enough to hold all four panels in a rigid, coplanar configuration (not shown), although, in such a configuration, presentation apparatus 100 will not be stably self-supporting, and would require the presence of a stabilizing foot or other structure, to maintain presentation apparatus 100 in an upright presentation orientation.

An alternative embodiment for a selective rigidity structure is shown in FIGS. 14-17, wherein presentation apparatus 100′ is shown, which is substantially identical to apparatus 100, such that corresponding structural elements are designated using like reference numerals augmented by a prime (′).

Accordingly, presentation apparatus 100′ is initially formed as a monolithic blank having outer layers 102′, 104′, and an inner layer 106′ of corrugated material. In a preferred embodiment of the invention, outer layer 102′ is formed from a single layer of bleached white paper (to form the “front” side that faces toward the observer), while outer layer 104 may be fabricated from a single layer of kraft paper (to form the “back” side that faces away from the observer). In alternative embodiments, either or both of the outer layers 102′, 104′ may be fabricated from multiple layers of material, of different types, as desired or dictated by the requirements of a particular application. Likewise, no specific gauge of flute is required to be employed in the corrugated layer 106, and any gauge may be employed as desired or required.

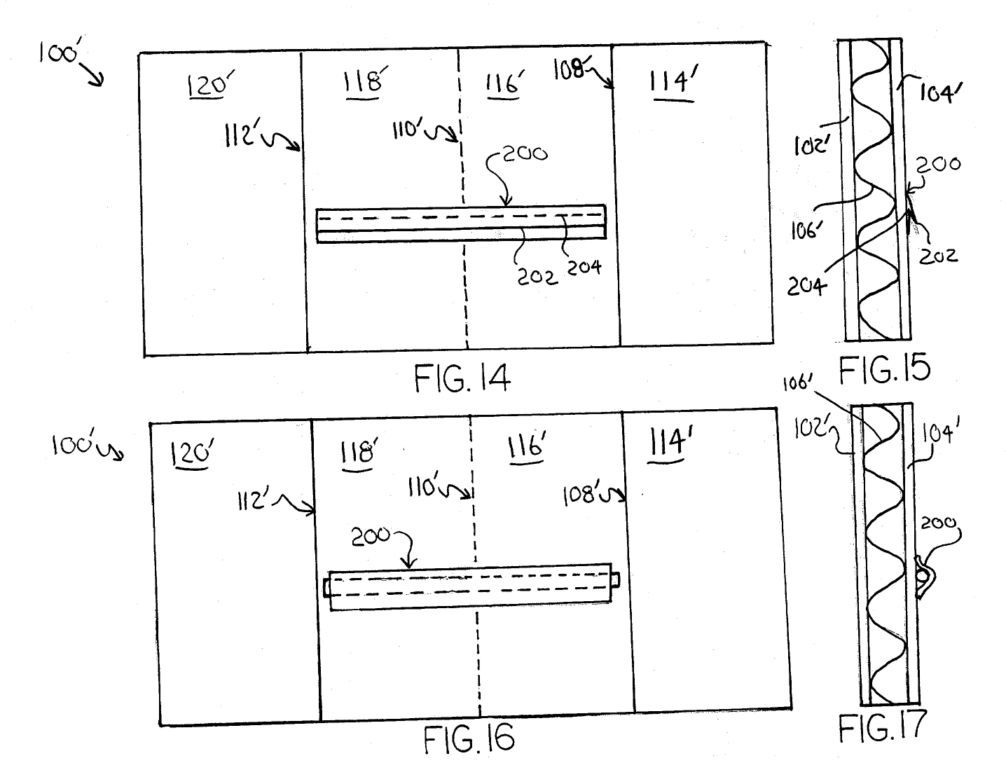

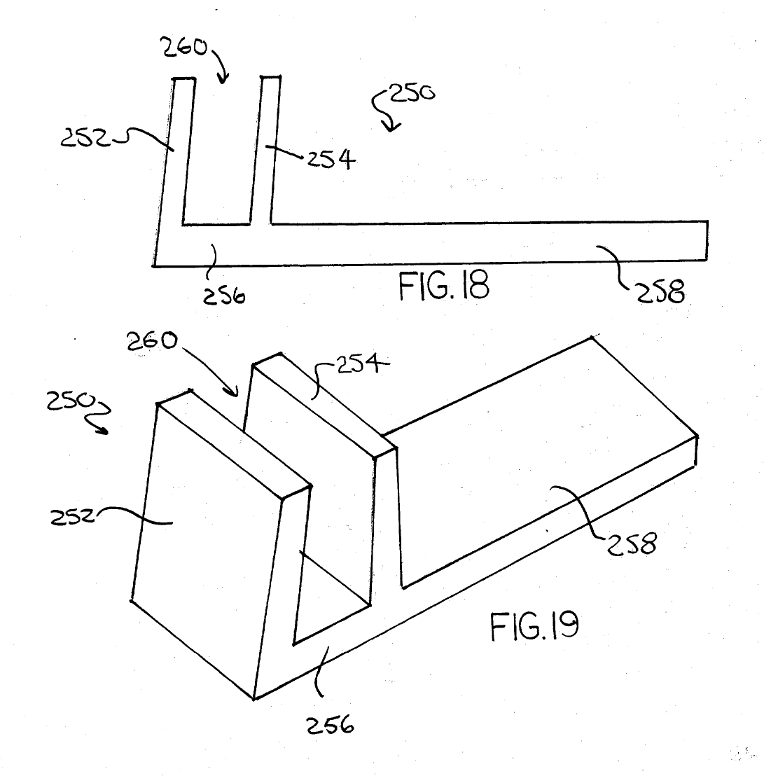

It is to be understood that in FIGS. 15 and 17, in which the thickness of apparatus 100′ is represented, that the thickness has been exaggerated relative to the illustrated height and width of apparatus 100′, for purposes of facilitating illustration of the various layers making up apparatus 100′. It is further to be understood that the actual thickness of an apparatus 100′ which may have dimensions, e.g., on the order of 4 feet (width) by 3 feet (height) may have a gross thickness (flat unfolded) on the order of ⅛ to 3/16 inches. It is to be additionally understood that the aspect ratio of height to width, as just given by example, or as illustrated in the drawings, is not intended to limit the scope of the invention, and that any suitable aspect ratio may be employed.

As stated above, apparatus 100′ is initially monolithically formed, and is subsequently provided with three “vertically extending” cuts 108′, 110′, 112′, which are approximately equally spaced apart. Cuts 108′ and 112′ extend from, and completely through, the “back” outer layer 104′, toward “front” outer layer 102′, and substantially or completely through corrugated layer 106′. Cut 110′, on the other hand, extends from, and completely through, “front” outer layer 102′, toward “back” outer layer 104′, and substantially or completely through corrugated layer 106′. Cuts 108′, 110′ and 112′ define relatively foldable panels 114′, 116′, 118′ and 120′. Cuts 108′, 110′, 112′ permit presentation apparatus 100′ to be folded, pleated, into a compact configuration, having a width approximately equal to the width of one panel.

A rear view of apparatus 100′ is shown in FIG. 14. A strip of material, preferably a thin, elongated sheet 200 of paperboard material, is affixed in any suitable manner, to the outer surface of layer 104′. While in an alternative embodiment, sheet 200 may be placed in a substantially flat manner onto the outer surface of layer 104′, for reasons which will be discussed hereinafter, preferably, sheet 200 will be longitudinally folded upon itself (as seen in FIGS. 14 and 15), prior to affixation, so that the fixed upper and lower edges of sheet 200 are closer together than the actual, straightened out “height” of sheet 200. Although sheet 200 does not need to be formally creased, as shown at 202 and 204, in FIGS. 14 and 15, such creasing is believed preferable, as it facilitates flattening of sheet 200, when apparatus 100′ is folded upon itself into a pleated configuration.

In order to provide selective rigidity, panels 118′ and 116′ will be oriented coplanar to one another. Then, a rod 206, which may be metal, wood or plastic, will be inserted between sheet 200 and outer layer 104′, causing sheet 200 to be “unfolded”, as shown in FIGS. 16 and 17. When it is desired to fold up apparatus 100′, rod 206 is simply removed.

While in a preferred embodiment, sheet 200 extends only across the joint formed by cut 110′, in alternative embodiments, additional strips (not shown) could be placed across the joints formed by cuts 112′ and/or 108′. In such an embodiment, wherein all of the panels would be held coplanar, again, apparatus 100′ would not be self-supporting in an upright orientation, and a stabilizing structure, would be required.

Such a stabilizing structure, which may be used with any of the embodiments shown or described herein, may be seen in FIGS. 18, 19, and in broken lines in FIG. 8. Support bracket 250 may be in the form of a simple clip, formed by (preferably) slightly inclined vertical limbs 252, 254, joined by web 256, and from which elongated leg 258 extends. Limbs 252, 254 and web 256 define a gap 260, into which the lower edge of a panel of one of the presentation apparatus may be positioned. The length of limbs 252, 254 and of leg 258 may be longer or shorter, and the inclination of limbs 252, 254 may be greater or lesser, as required by the dimensions and loading of the particular presentation apparatus.

Support bracket 250 is shown as simply one example of a possible structure, for providing support for maintaining a presentation apparatus of the present invention in an upright configuration, when the presentation apparatus is configured so that all four panels are coplanar, or for providing additional support, when the presentation apparatus is configured so that only the center two panels are coplanar, and the outer side panels are at oblique angles, relative to the two center panels. Other similar support structures may be readily adapted by those of ordinary skill in the art, having the present disclosure before them, without departing from the scope of the invention.

The foregoing description and drawings merely explain and illustrate the invention, and the invention is not limited thereto, except as those skilled in the art who have the present disclosure before them will be able to make modifications and variations therein without departing from the scope of the invention.

What is claimed is:

1. A presentation apparatus, for providing a plurality of upright-oriented planar surfaces for the positioning and display of planar exhibit materials, comprising:
a planar blank, having a front face and a back face, a top edge and a bottom edge, and first and second end edges;
a first cut disposed in the planar blank, at a location substantially midway between the first and second edges, from the top edge to the bottom edge, and from the back face toward but not through the front face;
a second cut disposed in the planar blank substantially midway between the first cut and the first edge, from the top edge to the bottom edge and from the front face toward but not through the front face;
a third cut disposed in the planar blank substantially midway between the first cut and the second edge, from the top edge to the bottom edge and from the front face toward but not through the front face;
the first, second and third cuts dividing the planar blank into four consecutive panels having substantially equal widths, and enabling the planar blank to be folded upon itself in a pleated configuration, and unfolded and re-folded on a plurality of occasions, without having to overcome significant resistance to folding and without rupturing or destroying layers of said blank.

2. The presentation apparatus according to claim 1, further comprising structure for providing selective rigidity to the presentation apparatus, when at least two adjacent panels of the presentation apparatus are disposed in coplanar relationship to one another.

3. The presentation apparatus according to claim 2, wherein the structure for providing selective rigidity comprises:
an elongated clip, having a U-shaped cross-sectional configuration, operably configured to be removably placed over one of the top and bottom edges of the blank, along a transition between adjacent panels thereof, the elongated clip providing resistance to folding of one of the adjacent panels, relative to the other of the adjacent panels.

4. The presentation apparatus according to claim 2, wherein the structure for providing selective rigidity comprises:
a sheet of material having a top edge and a bottom edge,
the sheet of material being affixed to one of the front and back faces of the planar blank, along a transition between adjacent panels thereof,
the sheet being affixed along the top and bottom edges thereof, to define an elongated passage extending between the sheet of material and the one of the front and back faces of the planar blank; and
an elongated rod, operably configured to be inserted into the elongated passage, and to extend along the transition between adjacent panels of the planar blank, when the adjacent panels have been disposed in coplanar relationship to one another.

5. The presentation apparatus according to claim 1, further comprising a structure for facilitating maintenance of the presentation apparatus in an upright configuration.

6. The presentation apparatus according to claim 5, wherein the structure for facilitating maintenance of the presentation apparatus in an upright configuration comprises:
at least one support bracket, having a clip portion, configured to releasably engage the planar blank along the bottom edge thereof, and an elongated leg, operably configured to extend away from the back face of the planar blank, at an included angle of less than 90 degrees relative thereto.

7. The presentation apparatus according to claim 1, wherein the planar blank comprises a front outer layer, a back outer layer, and an inner layer.

8. The presentation apparatus according to claim 7, wherein the front outer layer comprises at least one sheet of material.

9. The presentation apparatus according to claim 8, wherein the at least one sheet of material is fabricated from one of: paper, kraft paper, bleached white paper, clay coated paper.

10. The presentation apparatus according to claim 7, wherein the back outer layer comprises at least one sheet of material.

11. The presentation apparatus according to claim 10, wherein the at least one sheet of material is fabricated from one of: paper, kraft paper, bleached white paper, clay coated paper.

12. The presentation apparatus according to claim 7, wherein the inner layer comprises a layer of corrugated material.

13. The presentation apparatus according to claim 12, wherein the layer of corrugated material is fabricated from paper.
